(19) United States
(12) Patent Application Publication
(10) Pub. No.: US 2026/0329509 A1
(43) Pub. Date: Oct. 22, 2026

(54) DISPLAY DEVICE AND DISPLAY SYSTEM

(71) Applicant: LG ELECTRONICS INC., Seoul (KR)

(72) Inventors: Taeyoung KIM, Seoul (KR); Eunjung LEE, Seoul (KR); Donghee HAN, Seoul (KR); Yoonsuk JANG, Seoul (KR)

(73) Assignee: LG ELECTRONICS INC., Seoul (KR)

(21) Appl. No.: 19/119,386

(22) PCT Filed: Oct. 11, 2022
(86) PCT No.: PCT/KR2022/015267

§ 371 Date: Apr. 8, 2025

(51) Int. Cl. G06F 3/14

(52) U.S. Cl. CPC G06F 3/1423

(57) ABSTRACT

A first display device according to an embodiment of the present invention may comprise: an external device interface for connection with at least one external device; a wireless communication interface for connection with at least one second display device; and a controller which transmits, to the second display device, key information for controlling the external device.

### TECHNICAL FIELD

The present disclosure relates to a display device and a display system for controlling an external device connected to the display device using another display device.

### BACKGROUND ART

Digital TV services using wired or wireless communication networks are becoming widespread. Digital TV services can provide a variety of services that were not available with existing analog broadcasting services.

For example, IPTV (Internet Protocol Television), a type of digital TV service, and smart TV service provide interactivity that allows users to actively select the type of program to watch, the watching time, or the like. Based on this interactivity, IPTV and smart TV services can also provide various additional services, such as Internet search, home shopping, and online games.

The display device can be connected to various external devices including a set-top box, a Blu-ray player, a DVD player, a game console, a sound bar, a smartphone, a PC, a USB memory, and a home theater. In addition, the display device can be connected to another display device and provide a mirroring function to the other display device. Accordingly, the display device can receive image signals and audio signals from the external device and cause the image and audio provided by the external device to be output on the other display device.

However, the other display device may be in a different space from the display device. For example, the display device may be located in the user's living room, and the other display device may be located in the user's room. Additionally, an external device connected to the display device may be located around the display device. In other words, the external device may be located in the user's living room. In this case, when the other display device and the external device are physically separated, it may be difficult to watch a video in the space where the other display device is located and control the external device.

In addition, since the key information for controlling the external device is different for each external device, it is difficult for other display devices to store the key information for controlling all external devices, so there is a limit to the range in which other display devices control the external devices.

### DISCLOSURE

### Technical Problem

The present disclosure seeks to enable another display device, which is not directly connected to an external device, to control the external device without limitation.

### Technical Solution

A first display device according to an embodiment of the present disclosure includes an external device interface connecting with at least one external device; a wireless communication interface connecting with at least one second display device; and a controller transmitting key information for controlling the external device to the second display device.

The first display device according to an embodiment of the present disclosure may transmit a signal including information indicating whether the key information can be transmitted to the second display device when connected to one of the external device or the second display device while connected to the other one.

The first display device according to an embodiment of the present disclosure may transmit the key information to the second display device when receiving a signal requesting the key information from the second display device.

The first display device according to an embodiment of the present disclosure may receive key data selected from the second display device from the second display device, and generate a control signal for controlling the external device based on the selected key data and transmit the control signal to the external device.

The first display device according to an embodiment of the present disclosure may generate the control signal using one of CEC, a wireless network, and IR, and transmit the control signal to the external device.

The first display device according to an embodiment of the present disclosure may generate the CEC signal from the external device and transmit the CEC signal to the external device when the external device is connected to the first display device by wire and the external device is an external device controllable by the CEC method.

The first display device according to an embodiment of the present disclosure may generate the IR signal and transmit the IR signal to the external device when the external device is an external device that is not controllable by the CEC method.

The first display device according to an embodiment of the present disclosure may generate a network signal and transmit the network signal to the external device when the first display device and the external device are wirelessly connected and the external device is an external device that can be controlled in a network manner.

The first display device according to an embodiment of the present disclosure may generate the IR signal and transmit the IR signal to the external device when the external device is an external device that cannot be controlled in a network manner.

A display system according to an embodiment of the present disclosure includes a first display device and a second display device wirelessly connected to the first display device, the first display device may include an external device interface connecting with at least one external device; and a first controller transmitting key information for controlling the external device to the second display device; and the second display device may include a second controller displaying at least one icon corresponding to the key information received from the first controller.

The first display device of the display system according to an embodiment of the present disclosure may transmit a signal including whether the key information can be transmitted to the second display device when connected to one of the external device or the second display device while connected to the other one., and the second controller may display a message including whether the external device can be controlled based on the signal including whether the received key information can be transmitted.

The second display device of the display system according to an embodiment of the present disclosure may receive a user input for selecting one of the at least one icon and transmit key data corresponding to the selected icon to the first display device.

The first display device of the display system according to an embodiment of the present disclosure may generate a control signal for controlling the external device based on key data received from the second controller and transmit the control signal to the external device.

The first display device of the display system according to an embodiment of the present disclosure may receive at least a part of an image signal and an audio signal from an external device controlled based on the control signal and transmit at least a part of the image signal and the audio signal received from the external device to the second controller.

### Advantageous Effect

According to the present disclosure, a user has the advantage of being able to utilize external devices without limitation without having to directly connect the external devices to each display device.

In addition, according to the present disclosure, since the user does not have to move from place to place to control the external device, there is an advantage in that the continuity of use of the display device that is not directly connected to the external device is maximized.

### DESCRIPTION OF DRAWINGS

FIG. 1 is a block diagram illustrating a configuration of a display device according to an embodiment of the present disclosure.

FIG. 2 is a block diagram illustrating a remote control device according to an embodiment of the present disclosure.

FIG. 3 is a view illustrating an actual configuration of a remote control device

FIG. 4 is a view illustrating an example of utilizing the remote control device according to an embodiment of the present disclosure.

FIG. 5 is a ladder diagram for explaining a method for operating a display system comprising an external device, first and second display devices according to one embodiment of the present disclosure.

FIG. 6 is an example of a screen displayed on a second display device of a display system comprising an external device, first and second display devices according to one embodiment of the present disclosure.

FIG. 7 is a flowchart illustrating an operation of generating a signal for controlling an external device by a first display device of a display system comprising an external device, first display devices, and second display devices according to one embodiment of the present disclosure.

FIG. 8 is a view illustrating a screen displayed on a second display device when an external device connected to a first display device of a display system comprising an external device, first and second display devices according to one embodiment of the present disclosure is a set-top box.

FIG. 9 is a view illustrating a screen displayed on a second display device when the external device connected to the first display device of a display system comprising an external device, first and second display devices according to one embodiment of the present disclosure is a DVD player.

### BEST MODE

Hereinafter, embodiments relating to the present disclosure will be described in detail with reference to the accompanying drawings. The suffixes “interface”, “module” and “unit” for components used in the description below are assigned or mixed in consideration of easiness in writing the specification and do not have distinctive meanings or roles by themselves.

A display device according to an embodiment of the present disclosure, for example, as an artificial display device that adds a computer supporting function to a broadcast receiving function, can have an easy-to-use interface such as a writing input device, a touch screen, or a spatial remote control device as an Internet function is added while fulfilling the broadcast receiving function. Then, with the support of a wired or wireless Internet function, it is possible to perform an e-mail, web browsing, banking, or game function in access to Internet and computers. In order to perform such various functions, standardized general purpose OS can be used.

Accordingly, since various applications are freely added or deleted on a general purpose OS kernel, a display device described herein, for example, can perform various user-friendly functions. The display device, in more detail, can be a network TV, Hybrid Broadcast Broadband TV (HBBTV), smart TV, light-emitting diode (LED) TV, organic light-emitting diode (OLED) TV, and so on and in some cases, can be applied to a smartphone.

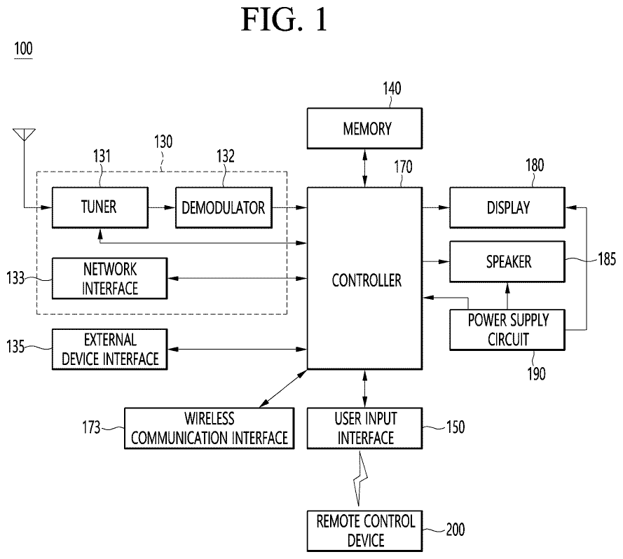

FIG. 1 is a block diagram illustrating a configuration of a display device according to an embodiment of the present disclosure.

Referring to FIG. 1, a display device 100 may include a broadcast reception module 130, an external device interface unit 135, a storage unit 140, a user input unit 150, a control unit 170, a wireless communication interface unit 173, a display unit 180, an audio output unit 185, and a power supply unit 190.

The broadcast reception module 130 may include a tuner 131, a demodulator 132, and a network interface 133.

The tuner 131 may select a specific broadcast channel according to a channel selection command. The tuner 131 may receive broadcast signals for the selected specific broadcast channel.

The demodulation unit 132 may divide the received broadcast signals into video signals, audio signals, and broadcast program-related data signals, and may restore the divided video signals, audio signals, and data signals into an output available form.

The external device interface unit 135 may receive an application or an application list in an adjacent external device and deliver the application or the application list to the control unit 170 or the storage unit 140.

The external device interface unit 135 may provide a connection path between the display device 100 and an external device. The external device interface unit 135 may receive at least one of an image or audio outputted from an external device that is wirelessly or wiredly connected to the display device 100 and deliver the received image or the audio to the controller. The external device interface unit 135 may include a plurality of external input terminals. The plurality of external input terminals may include an RGB terminal, at least one High Definition Multimedia Interface (HDMI) terminal, and a component terminal.

An image signal of an external device inputted through the external device interface unit 135 may be outputted through the display unit 180. A sound signal of an external device inputted through the external device interface unit 135 may be outputted through the audio output unit 185.

An external device connectable to the external device interface unit 135 may be one of a set-top box, a Blu-ray player, a DVD player, a game console, a sound bar, a smartphone, a PC, a USB Memory, and a home theater system but this is just exemplary.

The network interface 133 may provide an interface for connecting the display device 100 to a wired/wireless network comprising internet network. The network interface 133 may transmit or receive data to or from another user or another electronic device through an accessed network or another network linked to the accessed network.

Additionally, some content data stored in the display device 100 may be transmitted to a user or an electronic device, which is selected from other users or other electronic devices pre-registered in the display device 100.

The network interface unit 133 may access a predetermined webpage through an accessed network or another network linked to the accessed network. In other words, the network interface unit 133 may transmit or receive data to or from a corresponding server by accessing a predetermined webpage through the network.

The network interface unit 133 may receive content or data provided from a content provider or a network operator. In other words, the network interface unit 133 may receive content, such as movies, advertisements, games, VODs, and broadcast signals, which are provided from the content provider or the network operator, and information relating thereto through the network.

In addition, the network interface unit 133 may receive firmware update information and update files provided from the network operator, and may transmit data to the Internet or content provider or the network operator.

The network interface 133 may select and receive a desired application among applications open to the air, through network.

The storage unit 140 may store signal-processed image, voice, or data signals stored by a program in order for each signal processing and control in the control unit 170.

In addition, the storage unit 140 may perform a function for temporarily storing image, voice, or data signals output from the external device interface unit 135 or the network interface unit 133, and may store information on a predetermined image through a channel memory function.

The storage unit 140 may store an application or an application list input from the external device interface unit 135 or the network interface unit 133.

The display device 100 may play content files (e.g., video files, still image files, music files, document files, application files, etc.) stored in the storage unit 140, and may provide the content files to a user.

The user input unit 150 may transmit signals input by a user to the control unit 170, or may transmit signals from the control unit 170 to a user. For example, the user input unit 150 may receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR communication methods.

In addition, the user input unit 150 may transmit, to the control unit 170, control signals input from local keys (not illustrated) such as a power key, a channel key, a volume key, and a setting key.

Image signals that are image-processed by the control unit 170 may be input to the display unit 180 and displayed as images corresponding to the image signals. In addition, image signals that are image-processed by the control unit 170 may be input to an external output device through the external device interface unit 135.

Voice signals processed by the control unit 170 may be output to the audio output unit 185. In addition, voice signals processed by the control unit 170 may be input to the external output device through the external device interface unit 135.

Additionally, the control unit 170 may control overall operations of the display device 100.

In addition, the control unit 170 may control the display device 100 by a user command or an internal program input through the user input unit 150, and may access the network to download a desired application or application list into the display device 100.

The control unit 170 may output channel information selected by a user together with the processed image or voice signals through the display unit 180 or the audio output unit 185.

In addition, the control unit 170 may output image signals or voice signals of an external device such as a camera or a camcorder, which are input through the external device interface unit 135, through the display unit 180 or the audio output unit 185, according to an external device image playback command received through the user input unit 150.

Moreover, the control unit 170 may control the display unit 180 to display images, and may control the display unit 180 to display broadcast images input through the tuner 131, external input images input through the external device interface unit 135, images input through the network interface unit, or images stored in the storage unit 140. In this case, an image displayed on the display unit 180 may be a still image or video and also may be a 2D image or a 3D image.

Additionally, the control unit 170 may play content stored in the display device 100, received broadcast content, and external input content input from the outside, and the content may be in various formats such as broadcast images, external input images, audio files, still images, accessed web screens, and document files.

Moreover, the wireless communication unit 173 may perform wired or wireless communication with an external device. The wireless communication unit 173 may perform short-range communication with an external device. For this, the wireless communication unit 173 may support short-range communication by using at least one of Bluetooth™, Bluetooth Low Energy (BLE), Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 may support wireless communication between the display device 100 and a wireless communication system, between the display device 100 and another display device 100, or between networks including the display device 100 and another display device 100 (or an external server) through wireless area networks. The wireless area networks may be wireless personal area networks.

Herein, the other display device 100 may be a mobile terminal such as a wearable device (for example, a smart watch, a smart glass, and a head mounted display (HMD)) or a smartphone, which is capable of exchanging data (or inter-working) with the display device 100. The wireless communication unit 173 may detect (or recognize) a wearable device capable of communication around the display device 100.

Furthermore, if the detected wearable device is a device authenticated to communicate with the display device 100, the control unit 170 may transmit at least part of data processed in the display device 100 to the wearable device through the wireless communication unit 173. Therefore, a user of the wearable device may use the data processed by the display device 100 through the wearable device.

The display unit 180 may convert image signals, data signals, or on-screen display (OSD) signals, which are processed in the control unit 170, or images signals or data signals, which are received in the external device interface unit 135, into R, G, and B signals to generate driving signals.

Furthermore, the display device 100 illustrated in FIG. 1 is just one embodiment of the present disclosure and thus, some of the components illustrated may be integrated, added, or omitted according to the specification of the actually implemented display device 100.

In other words, if necessary, two or more components may be integrated into one component, or one component may be divided into two or more components. Additionally, a function performed by each block is to describe an embodiment of the present disclosure and its specific operation or device does not limit the scope of the present disclosure.

According to another embodiment of the present disclosure, unlike FIG. 1, the display device 100 may receive images through the network interface unit 133 or the external device interface unit 135 and play them without including the tuner 131 and the demodulation unit 132.

For example, the display device 100 may be divided into an image processing device such as a set-top box for receiving broadcast signals or contents according to various network services and a content playback device for playing content input from the image processing device.

In this case, an operating method of a display device according to an embodiment of the present disclosure described below may be performed by one of the display device described with reference to FIG. 1, an image processing device such as the separated set-top box, and a content playback device including the display unit 180 and the audio output unit 185.

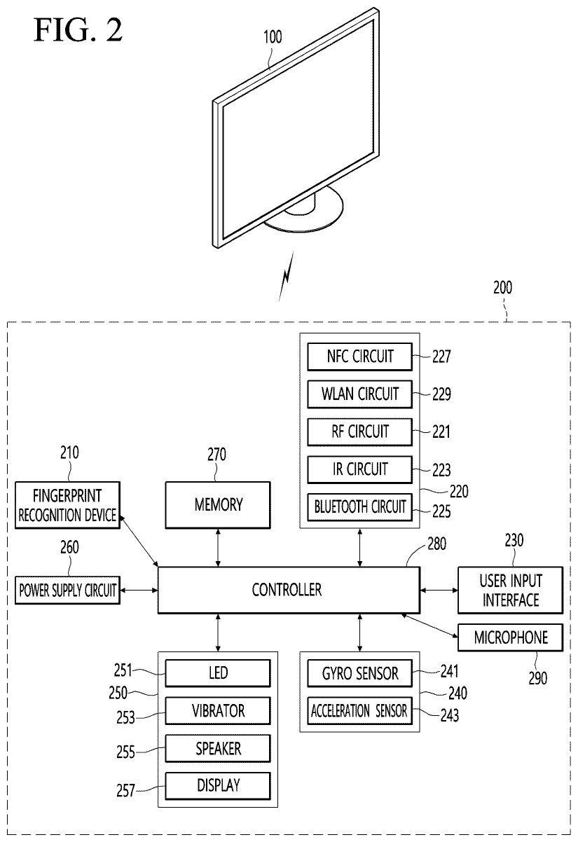

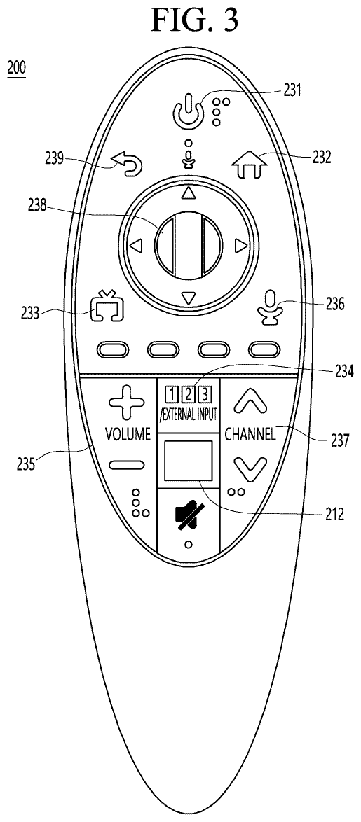

A remote control device according to an embodiment of the present disclosure will be described with reference to FIGS. 2 and 3.

FIG. 2 is a block diagram illustrating a remote control device according to an embodiment of the present disclosure and FIG. 3 is a view illustrating an actual configuration of a remote control device according to an embodiment of the present disclosure.

First, referring to FIG. 2, a remote control device 200 may include a fingerprint recognition unit 210, a wireless communication unit 220, a user input unit 230, a sensor unit 240, an output unit 250, a power supply unit 260, a storage unit 270, a control unit 280, and a sound acquisition unit 290.

Referring to FIG. 2, the wireless communication unit 220 transmits/receives signals to/from an arbitrary any one of display devices according to the above-mentioned embodiments of the present disclosure.

The remote control device 200 may include a radio frequency (RF) module 221 capable of transmitting or receiving signals to or from the display device 100 according to an RF communication standard, and an IR module 223 capable of transmitting or receiving signals to or from the display device 100 according to an IR communication standard. In addition, the remote control device 200 may include a Bluetooth module 225 capable of transmitting or receiving signals to or from the display device 100 according to a Bluetooth communication standard. In addition, the remote control device 200 may include an NFC module 227 capable of transmitting or receiving signals to or from the display device 100 according to an NFC communication standard, and a wireless LAN (WLAN) module 229 capable of transmitting or receiving signals to or from the display device 100 according to a WLAN communication standard.

In addition, the remote control device 200 may transmit signals containing information on the movement of the remote control device 200 to the display device 100 through the wireless communication unit 220.

Moreover, the remote control device 200 may receive signals transmitted from the display device 100 through the RF module 221 and if necessary, may transmit a command for power on/off, channel change, and volume change to the display device 100 through the IR module 223.

The user input unit 230 may be configured with a keypad, a button, a touch pad, or a touch screen. A user may operate the user input unit 230 to input a command relating to the display device 100 to the remote control device 200. If the user input unit 230 includes a hard key button, a user may input a command relating to the display device 100 to the remote control device 200 through the push operation of the hard key button. This will be described with reference to FIG. 3.

Referring to FIG. 3, the remote control device 200 may include a plurality of buttons. The plurality of buttons may include a fingerprint recognition button 212, a power button 231, a home button 232, a live button 233, an external input button 234, a volume control button 235, a voice recognition button 236, a channel change button 237, an OK button 238, and a back button 239.

The fingerprint recognition button 212 may be a button for recognizing a user's fingerprint. According to an embodiment of the present disclosure, the fingerprint recognition button 212 may perform a push operation and receive a push operation and a fingerprint recognition operation.

The power button 231 may be a button for turning on/off the power of the display device 100.

The home button 232 may be a button for moving to the home screen of the display device 100.

The live button 233 may be a button for displaying live broadcast programs.

The external input button 234 may be a button for receiving an external input connected to the display device 100.

The volume control button 235 may be a button for controlling a volume output from the display device 100.

The voice recognition button 236 may be a button for receiving user's voice and recognizing the received voice.

The channel change button 237 may be a button for receiving broadcast signals of a specific broadcast channel.

The OK button 238 may be a button for selecting a specific function, and the back button 239 may be a button for returning to a previous screen.

FIG. 2 is described again.

If the user input unit 230 includes a touch screen, a user may touch a soft key of the touch screen to input a command relating to the display device 100 to the remote control device 200. In addition, the user input unit 230 may include various kinds of input interfaces operable by a user, for example, a scroll key and a jog key, and this embodiment does not limit the scope of the present disclosure.

The sensor unit 240 may include a gyro sensor 241 or an acceleration sensor 243. The gyro sensor 241 may sense information on the movement of the remote control device 200.

For example, the gyro sensor 241 may sense information on an operation of the remote control device 200 on the basis of x, y, and z axes and the acceleration sensor 243 may sense information on a movement speed of the remote control device 200. Moreover, the remote control device 200 may further include a distance measurement sensor that senses a distance with respect to the display unit 180 of the display device 100.

The output unit 250 may output image or voice signals in response to the operation of the user input unit 230, or may output image or voice signals corresponding to signals transmitted from the display device 100.

A user may recognize whether the user input unit 230 is operated or the display device 100 is controlled through the output unit 250.

For example, the output unit 250 may include an LED module 251 for flashing, a vibration module 253 for generating vibration, a sound output module 255 for outputting sound, or a display module 257 for outputting an image, if the user input unit 230 is manipulated or signals are transmitted/received to/from the display device 100 through the wireless communication unit 220.

Additionally, the power supply unit 260 supplies power to the remote control device 200 and if the remote control device 200 does not move for a predetermined time, stops the power supply, so that power waste may be reduced.

The power supply unit 260 may resume the supply of power if a predetermined key provided at the remote control device 200 is operated.

The storage unit 270 may store various kinds of programs and application data required to control or operate the remote control device 200.

If the remote control device 200 transmits/receives signals wirelessly through the display device 100 and the RF module 221, the remote control device 200 and the display device 100 transmits/receives signals through a predetermined frequency band.

The control unit 280 of the remote control device 200 may store, in the storage unit 270, information on a frequency band for transmitting/receiving signals to/from the display device 100 paired with the remote control device 200 and refer to it.

The control unit 280 controls general matters relating to the control of the remote control device 200. The control unit 280 may transmit a signal corresponding to a predetermined key operation of the user input unit 230 or a signal corresponding to the movement of the remote control device 200 sensed by the sensor unit 240 to the display device 100 through the wireless communication unit 220.

In addition, the sound acquisition unit 290 of the remote control device 200 may acquire voice.

The sound acquisition unit 290 may include at least one microphone and acquire voice through the microphone.

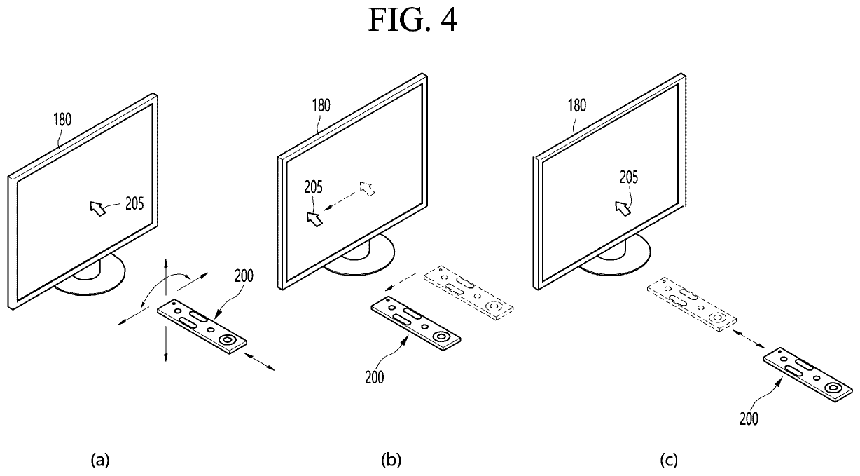

Next, FIG. 4 is described.

FIG. 4 is a view illustrating an example of utilizing a remote control device according to an embodiment of the present disclosure.

FIG. 4(a) illustrates that a pointer 205 corresponding to the remote control device 200 is displayed on the display unit 180.

A user may move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 may be referred to as a spatial remote control device.

FIG. 4(b) illustrates that if a user moves the remote control device 200, the pointer 205 displayed on the display unit 180 of the display device 100 is moved to the left according to the movement of the remote control device 200.

Information on a movement of the remote control device 200 detected through a sensor of the remote control device 200 is transmitted to the display device 100. The display device 100 may calculate the coordinates of the pointer 205 from the information on the movement of the remote control device 200. The display device 100 may display the pointer 205 to match the calculated coordinates.

FIG. 4(c) illustrates that while a specific button in the remote control device 200 is pressed, a user moves the remote control device 200 away from the display unit 180. Thus, a selected region in the display unit 180 corresponding to the pointer 205 may be zoomed in and displayed in an enlarged size.

On the other hand, if a user moves the remote control device 200 close to the display unit 180, a selection area in the display unit 180 corresponding to the pointer 205 may be zoomed out and displayed in a reduced size.

On the other hand, if the remote control device 200 is moved away from the display unit 180, a selection area may be zoomed out and if the remote control device 200 is moved closer to the display unit 180, a selection area may be zoomed in.

Additionally, if a specific button in the remote control device 200 is pressed, recognition of a vertical or horizontal movement may be excluded. In other words, if the remote control device 200 is moved away from or closer to the display unit 180, the up, down, left, or right movement cannot be recognized and only the back and forth movement may be recognized. While a specific button in the remote control device 200 is not pressed, only the pointer 205 is moved according to the up, down, left or right movement of the remote control device 200.

Moreover, the moving speed or moving direction of the pointer 205 may correspond to the moving speed or moving direction of the remote control device 200.

Furthermore, a pointer in this specification means an object displayed on the display unit 180 in response to an operation of the remote control device 200. Therefore, in addition to the arrow form displayed as the pointer 205 in the drawing, various forms of objects are possible. For example, the above concept includes a point, a cursor, a prompt, and a thick outline. Then, the pointer 205 may be displayed in correspondence to one point of a horizontal axis and a vertical axis on the display unit 180 and also may be displayed in correspondence to a plurality of points such as a line and a surface.

As described above, the display device 100 can be connected to various external devices including a set-top box, a Blu-ray player, a DVD player, a game console, a sound bar, a smartphone, a PC, a USB memory, and a home theater. In addition, the display device 100 can be connected to another display device to provide a mirroring function in which an image displayed on the display device 100 is displayed as is on the other display device. Accordingly, the display device 100 can receive an image signal and an audio signal from the external device and can cause the image and audio provided by the external device to be output on the other display device.

However, the other display device may be in a different space from the display device 100. If the other display device and the external device are physically separated, there is a limit to the range of controlling the external device while watching the image in the space where the other display device is located.

Additionally, since the key information for controlling the external device is different for each external device, it is difficult for other display devices to store the key information for controlling all external devices.

Accordingly, a display device 100 according to one embodiment of the present disclosure is intended to enable control of an external device from another display device without limitation.

To this end, a display device 100 according to one embodiment of the present disclosure is intended to transmit key information for controlling an external device to another display device.

For convenience of explanation, below, a display device 100 directly connected to an external device is named a first display device, and another display device connected to the display device 100 is named a second display device 300.

Other display devices may include at least some or all of the same configurations as those included in the display device 100. In other words, both the first display device 100 and the second display device 300 may be the display devices 100 described in FIG. 1, but they are distinguished only for convenience of explanation. Similarly, for convenience of explanation, the controller 170 and the display 180 of the first display device 100 are named as the first controller and the first display, respectively, and the controller, display, and speaker of the second display device 300 are named as the second controller 370, the second display 380, and the second speaker, respectively.

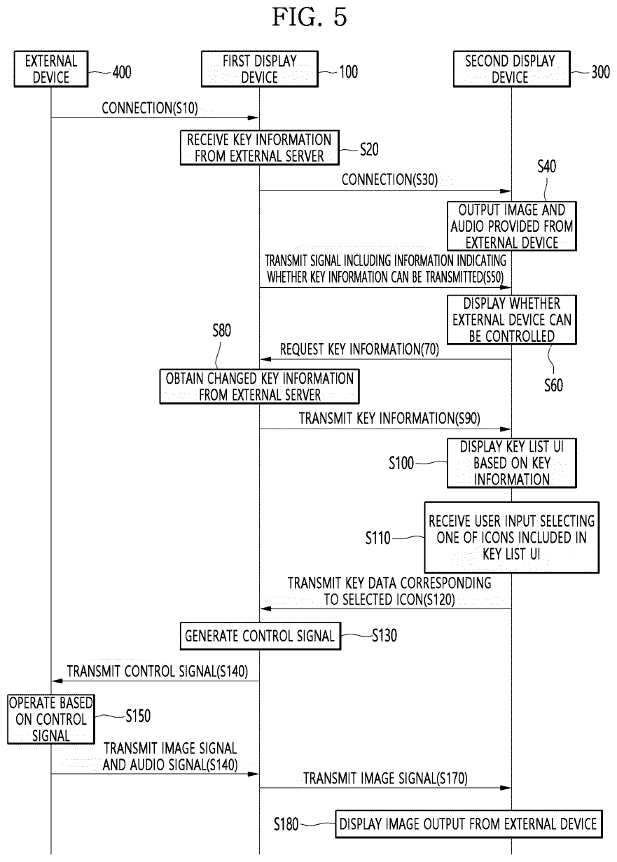

Next, referring to FIG. 5, a method for operating a display system comprising an external device, first and second display devices according to one embodiment of the present disclosure will be described.

FIG. 5 is a ladder diagram for explaining a method for operating a display system comprising an external device, first and second display devices according to one embodiment of the present disclosure.

The first display device 100 can be connected to an external device 400 (S10).

The first controller 170 can receive at least some of the image signals and audio signals from the external device 400 when the first display device 100 and the external device 400 are connected. Although not illustrated in the drawing, the image and audio provided by the external device 400 can be output from the first display device 100.

When the first display device 100 is connected to an external device 400, the first display device can receive key information for controlling the external device 400 (S20).

When the first controller 170 is connected to an external device 400, the first controller can receive key information for controlling the external device 400 from an external server (not illustrated). Meanwhile, the key information may be stored in the first display device 100, and when the key information is stored in the first display device 100, the step of receiving the key information from the external server (not illustrated) may be omitted. In addition, the first display device 100 may also receive key information for controlling the external device 400 directly from the external device 400.

The key information may be a key list for controlling an external device 400.

Key information can include key type, key name, or the like. For example, key types can be number keys, function keys, color keys, player keys, or the like. In addition, examples of key names may include ‘0’, ‘1’, ‘2’, or the like for number keys, ‘power’, ‘home’, or the like for function keys, ‘red’, ‘green’, or the like for color keys, and ‘backward’, ‘play’, or the like for player keys.

Key information may vary according to the type and model of the external device 400. In other words, the type and the key name may vary according to the type and model of the external device 400.

The first display device 100 can be connected to the second display device 300 (S30).

The first controller 170 can transmit image signals and audio signals received from an external device 400 to the second display device 300. Alternatively, the first controller 170 can transmit a mirroring signal to the second display device 300 so that image and audio that can be output from the first display device 100 can be output from the second display device 300 based on the received image and audio signals.

Accordingly, the second display device 300 can output images and audio provided by the external device 400 (S40).

The second controller 380 can cause images and audio provided by an external device 400 to be output from the second display device 300 based on image signals and audio signals received from the first display device 100 or mirroring signals.

In other words, the image and audio provided by the external device 400 can be output from some or all of the first display device 100 and the second display device 300.

The first display device 100 can transmit a signal including information indicating whether key information can be transmitted to the second display device 300 (S50).

In steps S10 to S40, it has been described that the external device 400 and the first display device 100 are connected first, and then the first display device 100 and the second display device 300 are connected, but the order in which each device is connected is not limited thereto.

The first display device 100 can transmit a signal including information indicating whether key information can be transmitted to the second display device 300 when connected to one of the external device 400 or the second display device 300 while connected to the other one.

Specifically, when the first controller 170 is connected to the second display device 300 while connected to the external device 400, the first controller 170 may transmit a signal including information indicating whether key information for controlling the external device 400 can be transmitted to the second controller 370. Alternatively, when the first controller 170 is connected to the external device 400 while connected to the second display device 300, the first controller 170 may transmit a signal including information indicating whether key information for controlling the external device 400 can be transmitted to the second controller 370.

The first controller 170 may transmit a signal including information indicating that key information can be transmitted to the second controller 370 when key information is stored in the first display device 100 or key information can be received from an external server (not illustrated).

On the other hand, if key information is not stored in the first display device 100 and key information cannot be received from an external server (not illustrated), the first controller 170 may transmit a signal including information indicating that key information transmission is impossible to the second controller 370.

The second display device 300 can display whether an external device 400 can be controlled based on a signal including information indicating whether key information transmission is possible (S60).

Since the second controller 370 can control the external device 400 without limitation only when the second controller can receive key information for controlling the external device 400 from the first controller 170, the second controller can display on the second display 380 whether the external device 400 can be controlled based on a signal including information indicating whether key information transmission is possible.

When the second controller 370 receives a signal including information indicating that key information transmission is possible from the first controller 170, the second controller can display on the second display 380 that control of the external device 400 is possible.

On the other hand, if the second controller 370 receives a signal including information indicating that key information transmission is impossible from the first controller 170, the second controller may display on the second display 380 that control of the external device 400 is impossible.

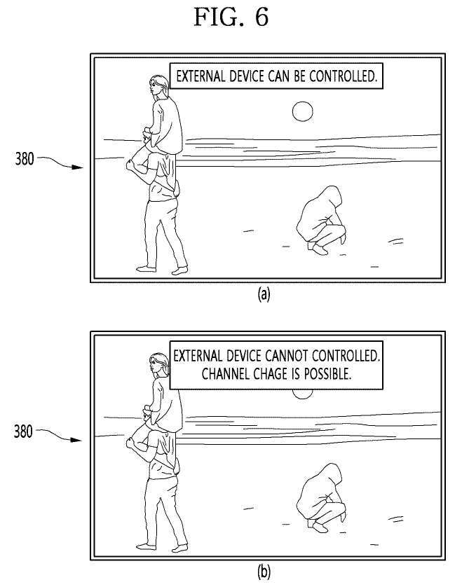

In relation to this, an operation of indicating whether a second display device 300 of a display system according to one embodiment of the present disclosure can control an external device (400) will be specifically described with reference to FIG. 6.

FIG. 6 is an example of a screen displayed on a second display device of a display system comprising an external device, first and second display devices according to one embodiment of the present disclosure.

When the second controller 370 transmits a signal including information indicating whether key information can be transmitted from the first controller 170, the second controller 370 can display a message including whether the external device 400 can be controlled based on the signal including information indicating whether key information can be transmitted. In other words, the second controller 170 can display a message including whether the external device 400 can be controlled based on whether key information can be received from the first display device 100.

Specifically, if the signal received from the first controller 170 includes information indicating that key information can be provided, the second controller 370 can display a message on the second display 380 that says, “the external device can be controlled,” as illustrated in FIG. 6(a). In other words, if the signal received from the first controller 170 includes information indicating that key information can be provided, the second controller 370 can display on the second display 380 that control of the external device 400 is possible.

In addition, if the second controller 370 includes information indicating that key information cannot be provided in the signal received from the first controller 170, the second controller 370 may display a message on the second display 380 that says, ‘The external device cannot be controlled.’, as illustrated in FIG. 6(b). In other words, the second controller 370 may display on the second display 380 that the external device 400 cannot be controlled.

Meanwhile, even if key information cannot be received from the first display device 100 according to an embodiment, the second display device 100 may be able to control the external device 400 for basic functions. The basic function may be a function commonly included in the external device 400 to provide content. For example, the basic function may be a channel change function or a power function. In other words, the second display device 100 may not be able to receive key information from the first display device 100, but may be able to control a part of the external device 400. In this case, when key information cannot be received from the first display device 100, but a part of the external device 400 can be controlled, the second controller 370 may further display a message indicating that a part of the external device 400 can be controlled. If the second controller 370 can control a part of the external device 400, the second controller can additionally display a message such as ‘Channel change is possible’ on the second display 380 as illustrated in FIG. 6(b).

Meanwhile, the second controller 370 may indicate whether the external device 400 can be controlled only when key information cannot be received, or may indicate whether the external device 400 can be controlled only when key information can be received. In addition, the second controller 370 may indicate whether the external device 400 can be controlled both when key information cannot be received and when key information can be received.

As the second controller 370 indicates whether the external device 400 can be controlled, the user of the second display device 300 can determine in advance whether the external device 400 can be controlled without restrictions, thereby minimizing inconvenience caused by unexpected restrictions while watching a video.

Again, FIG. 5 is explained.

The second display device 300 can request key information transmission to the first display device 100 (S70).

According to one embodiment, the second controller 370 may request key information transmission to the first display device 100 only when the first display device 100 transmits a signal that includes information indicating that key information transmission is possible.

In another embodiment, the second controller 370 may request the first display device 100 to transmit key information regardless of information indicating whether key information transmission is possible included in a signal transmitted by the first display device 100. For example, when the second controller 370 receives a user input, the second controller may request the first controller 170 to transmit key information.

When the first display device 100 receives a request for key information transmission from the second display device 300, the first display device can obtain from an external server whether there is a change in the key information, and if there is a change, the first display device can receive the changed key information (S80).

When the first controller 170 receives a request for key information transmission from the second controller 370, the first controller can obtain whether there is a change in the key information in an external server (not illustrated).

A change in key information may be a case where a new model of external device 400 is released and all key information corresponding to the new model of external device 400 is added. Alternatively, a change in key information may be a case where at least a part of key information is modified or added due to an update of an existing external device 400.

When there is a change in key information, the first controller 170 can receive the changed key information from an external server (not illustrated).

Meanwhile, the first controller 170 may not receive key information from an external server (not illustrated) if there is no change in key information and key information for controlling an external device 400 is stored in the first display device 100.

The first display device 100 can transmit key information to the second display device 300 (S90).

The first controller 170 can transmit key information received from an external server (not illustrated) or key information stored in the first display device 100 to the second controller 370.

The second display device 300 can display a key list UI based on the received key information (S100).

The key list UI may be a UI that displays at least one selectable key based on key information received by the second controller 370. The key list UI may vary according to the key information received by the second controller 370.

The second controller 370 can display a key list UI on the second display 380 based on the received key information. The key list UI can include icons corresponding to keys for controlling at least one external device 400.

Since the key list UI may differ according to the key information received by the second controller 370, it may be displayed differently according to the external device 400 connected to the first display device 100.

The second display device 300 can receive a user input for selecting one of the icons included in the key list UI (S110).

The second display device 300 may receive user input from a remote control device (not illustrated) or may receive user input by detecting an input touching the second display 380, but this is only an example.

The second display device 300 can transmit key data corresponding to the selected icon (S120).

When the second controller 370 receives a user input for selecting one of the items or icons included in the key list UI from an external device 400, the second controller 370 can transmit key data corresponding to the selected icon to the first controller 170 based on the

The key data may be data of a key corresponding to a selected icon. The key data may include the key type and key name corresponding to the selected icon. In addition, the key data may further include identification information of an external device 400 in order to identify which external device is controlled when a plurality of external devices 400 are connected to the first display device 100.

The first display device 100 can generate a control signal for controlling an external device 400 based on the received key data (S130) and transmit the generated control signal to the external device 400 (S140).

Meanwhile, since the external device 400 connected to the first display device 100 may be diverse, the method by which the first display device 100 controls the external device 400 may also be diverse. For example, the external device 400 may be controlled by any one of CEC (Consumer Electronics Control), a wireless network, and IR (Infrared). In other words, the first display device 100 may control the external device 400 by transmitting a control signal generated by using any one of CEC, a wireless network, and IR to the external device 400.

Accordingly, the first display device 100 according to one embodiment of the present disclosure generates a control signal using one of CEC, a wireless network, and IR, and transmits the control signal to the external device 400 based on a preset priority according to the external device 400 connected to the first display device 100.

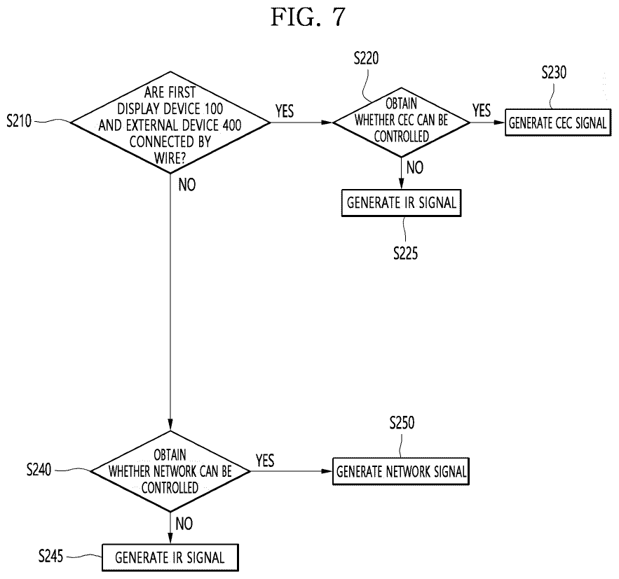

In relation to this, an example of generating a control signal using one of CEC, a wireless network, and IR based on a preset priority according to a connected external device 400 is specifically described with reference to FIG. 7.

FIG. 7 is a flowchart illustrating an operation of generating a signal for controlling an external device by a first display device of a display system comprising an external device, first display devices, and second display devices according to one embodiment of the present disclosure.

The first controller 170 can obtain a connection method between the first display device 100 and the external device 400 (S210).

The first display device 100 and the external device 400 can be connected by wire or wirelessly. The first controller 170 can obtain whether the first display device 100 and the external device 400 are connected by wire or wirelessly.

The first controller 170 can obtain whether the external device is an external device controllable by the CEC method when the first display device 100 and the external device 400 are connected by a wire (S220). If the first controller 170 obtains that the external device 400 is an external device controllable by the CEC method, the first controller 170 can generate a CEC signal (S230). On the other hand, if the first controller 170 obtains that the external device 400 is an external device that cannot be controlled by the CEC method, the first controller 170 can generate an IR signal.

In other words, the first controller 170 can generate a CEC signal and transmit the CEC signal to the external device 400 when the external device 400 can be controlled by both CEC and IR. Since control via CEC can be more stable than control via IR, control via CEC is given a higher priority among CEC and IR.

The first controller 170 can obtain whether the external device is an external device controllable in a network manner when the first display device 100 and the external device 400 are wirelessly connected (S240). If the first controller 170 obtains that the external device 400 is an external device controllable in a network manner, the first controller 170 can generate a network signal (S24). On the other hand, if the first controller 170 obtains that the external device is an external device that cannot be controlled in a network manner, the first controller 170 can generate an IR signal.

In other words, the first controller 170 can generate a network signal and transmit the network signal to the external device 400 when the external device 400 can be controlled by both the network and IR. Since control via the network can be more stable than control via IR, control via IR is given a higher priority among the network and IR.

Meanwhile, when CEC or network is unavailable, the IR signal generated can be generated based on the key data and IR DB received from the second controller 370. The IR DB can be stored in the first display device 100 or stored in an external server (not illustrated) so that the first controller 170 can receive the IR DB from the external server (not illustrated).

The generated IR signal can be transmitted to an external device 400 via the remote control device 200 if the remote control device 200 can receive the IR signal and transmit the IR signal to the external device 400.

If the remote control device 200 cannot receive an IR signal and transmit the IR signal to the external device 400, the IR signal may be transmitted to the external device 400 through the IR Blaster included in the display device 100. The IR Blaster included in the display device 100 may be at least one of a wired IR Blaster and a wireless IR Blaster. If the display device 100 includes both a wired IR Blaster and a wireless IR Blaster, the generated IR signal may be transmitted to the external device 400 through the wired IR Blaster.

In other words, IR signals can be transmitted in the order of priority: remote control device 200, wired IR Blaster, and wireless IR Blaster.

In summary, the first controller 170 generates a CEC signal when the first display device 100 and the external device 400 are connected by wire, but can generate an IR signal when CEC control is not possible. In addition, the first controller 170 generates a network signal when the first display device 100 and the external device 400 are connected wirelessly, but can generate an IR signal when network control is not possible.

However, such priorities are merely exemplary, and the first controller 170 may also generate control signals based on priorities set in other ways.

Since the first controller 170 generates a control signal based on a preset priority, when key data is received from the second display device 300 once, the external device 400 can be controlled once. In other words, there is an advantage in that cases where the external device 400 is controlled repeatedly can be prevented.

Again, FIG. 5 is explained.

The external device 400 operates based on the received control signal (S150) and can transmit at least some of the image signal and audio signal to the first display device 100 (S150).

The first controller 170 can receive at least some of the image signals and audio signals from an external device 400 that operates based on a control signal. Although not illustrated in the drawing, the first display device 100 can output the image and audio provided by the external device 400 that operates based on the control signal.

The first display device 100 can receive an image signal and an audio signal from an external device 400 that operates based on a control signal (S160).

In addition, the first display device 100 can transmit an image signal and an audio signal received from an external device 400 that operates based on a control signal to the second display device 300 (S170).

The first controller 170 can transmit an image signal and an audio signal received from an external device 400 that operates based on a control signal to the second display device 300. Alternatively, the first controller 170 can transmit a mirroring signal to the second display device 300 so that the image and audio that can be output from the first display device 100 can be output from the second display device 300 based on the received image and audio signals.

Accordingly, the second display device 200 can output some of the images and audio provided by the external device 400 (S180).

The second controller 380 can cause the image and audio provided by an external device 400 that operates based on a control signal based on an image signal and audio signal received from the first display device 100, or a mirroring signal, to be output from the second display device 300.

In other words, images and audio provided by an external device 400 controlled based on a control signal can be output from some or all of the first display device 100 and the second display device 300.

To summarize FIG. 5, the first display device and the display system according to one embodiment of the present disclosure can display a menu for controlling an external device 400 based on key information received from the first display device 100 by the second display device 300. Then, when the first display device 100 receives key data selected to control the external device 400 from the second display device 300, the first display device can generate a control signal and transmit the control signal to the external device 400. Accordingly, images and audio provided by the external device 400 operating based on the control signal can be output from at least some of the first display device 100 and the second display device 300.

In other words, the user can control the external device 400 without limitation using the second display device 300.

Accordingly, the user can use the external device 400 without limitation without directly connecting the external device 400 to each display device.

In addition, since the user does not need to move close to the external device 400 to control the external device 400, there is an advantage in that the continuity of use of the second display device 300 is maximized.

Next, a specific embodiment of controlling an external device 400 from a second display device according to an external device 400 connected to a first display device 100 of a display system comprising an external device, first and second display devices according to an embodiment of the present disclosure will be described.

First, the external device 400 connected to the first display device 100 may be a set-top box.

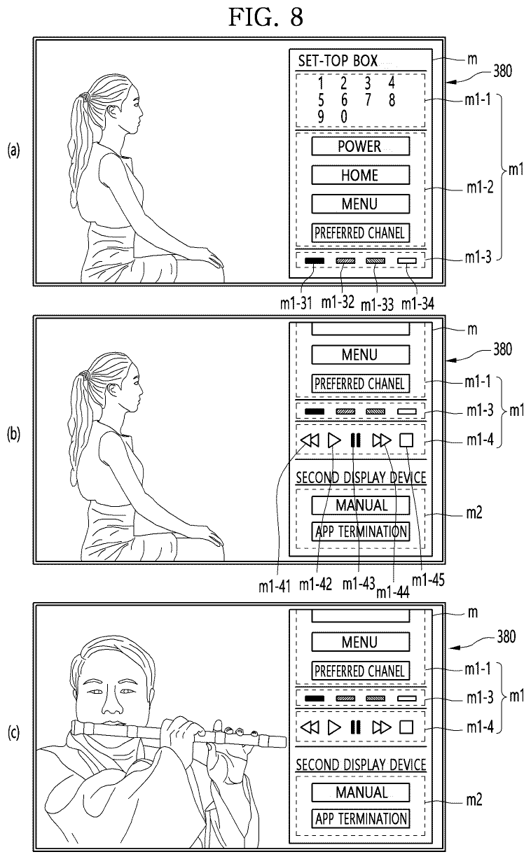

FIG. 8 is a view illustrating a screen displayed on a second display device when an external device connected to a first display device of a display system comprising an external device, first and second display devices according to one embodiment of the present disclosure is a set-top box.

FIG. 8(a) is an example of a screen in which the second controller 370 receives key information and displays a key list UI (m1) on the second display 380. Referring to FIG. 8(a), the key list UI (m1) may be included in the entire menu m. The entire menu m may be a menu displayed to control at least a part of the second display device 300 or the external device 400 when the second display device 300 receives a user input.

Meanwhile, FIG. 8(b) is a scrolled down screen of the entire menu m illustrated in FIG. 8(a). Referring to FIG. 8(b), the entire menu m may further include a menu m2 for controlling the second display device 300.

In FIG. 8, it is assumed that the external device 400 connected to the first display device 100 is a set-top box. Accordingly, the key list UI illustrated in FIG. 8 may be a menu m1 for controlling the set-top box.

The name of the set-top box may be displayed at the top of the menu m1 for controlling the set-top box so that it can be recognized that it is a menu m1 for controlling the set-top box. In other words, the name of the external device 400 may be displayed at the top of the menu m1 for controlling the external device 400 so that it can be recognized that it is a menu m1 for controlling the external device 400.

The key list UI m1 may include items corresponding to the key types. Additionally, the items corresponding to the key types may include icons corresponding to the key names.

A menu m1 for controlling a set-top box may include items corresponding to key types, such as items m1-1 corresponding to number keys, items m1-2 corresponding to function keys, items m1-3 corresponding to color keys, and items m1-4 corresponding to player keys.

Items m1-1 corresponding to the number keys may contain icons corresponding to keys with key names of ‘0’, ‘1’, ‘2’, ‘3’, ‘4’, ‘5’, ‘6’, ‘7’, ‘8’, ‘9’.

Items m1-1 corresponding to function keys may include icons corresponding to keys with key names of ‘Power’, ‘Home’, ‘Menu’, and ‘Favorite Channel’.

An item m1-3 corresponding to a color key may contain icons corresponding to keys with key names of ‘red’ m1-31, ‘green’ m1-32, ‘yellow’ m1-33, and ‘blue’ m1-34.

Items m1-4 corresponding to player keys may include icons corresponding to keys named ‘Rewind’ m1-41, ‘Play’ m1-42, ‘Pause’ m1-43, ‘Fast Forward’ m1-44, and ‘Stop’ m1-45.

However, the key types described above, items corresponding to the key types, key names, and icons corresponding to the key names are merely examples and are not limited thereto.

Meanwhile, the name of the second display device 300 may be displayed at the top of the menu m2 for controlling the second display device 300 to distinguish it from the menu m1 for controlling the set-top box.

The menu m2 for controlling the second display device 300 may include a user manual item and an app termination item. When the second controller 370 receives a user input for selecting a user manual item, the second controller 370 may display the user manual of the second display device 100 on the second display 380. In addition, when the second controller 370 receives a user input for selecting an app termination item, the second controller 370 may terminate the app running on the second display device 300.

In other words, when the second controller 370 receives a user input for selecting an item included in the menu m2 for controlling the second display device 300 from the entire menu m, the second controller 370 can control the operation of the second display device 300.

Accordingly, the user can easily select which device to control among the external device 400 and the second display device 300.

FIG. 8(c) is an example of a screen in which an image provided by a set-top box operating based on a control signal is displayed on a second display device 300.

Specifically, FIG. 8(c) may be a screen displayed when the second controller 370 receives a user input for selecting an icon corresponding to the ‘preferred channel’ key included in the menu m1 for controlling the set-top box.

When the second controller 370 receives a user input for selecting an icon corresponding to the ‘preferred channel’ key, the second controller 370 transmits key data of the ‘preferred channel’ key to the first display device 100, and the first controller 170 can generate a control signal corresponding to the ‘preferred channel’ key based on the received key data and transmit the control signal to the set-top box. Then, the set-top box that receives the control signal corresponding to the ‘preferred channel’ key can provide an image by switching the channel to the preferred channel as in the case where it directly receives a user input for selecting the ‘preferred channel’ key. Accordingly, the image provided by the set-top box by switching the channel can be displayed on the second display 380.

In other words, the user can control the set-top box using the second display device 300.

Meanwhile, the external device 400 connected to the first display device 100 may be a DVD player rather than a set-top box.

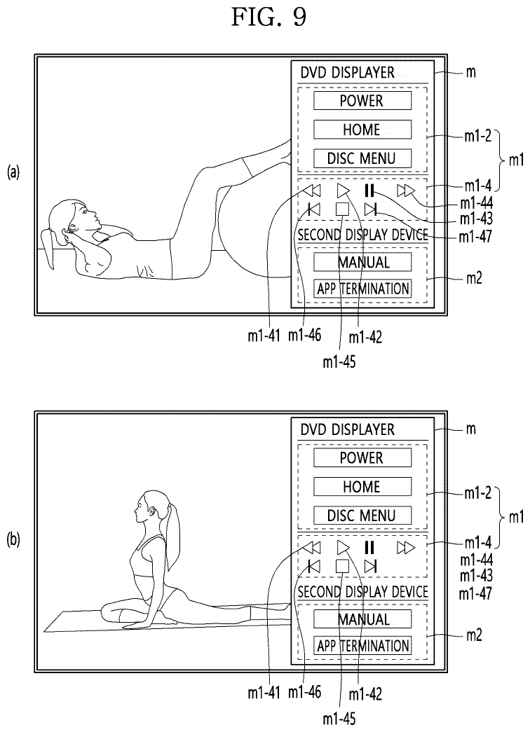

FIG. 9 is a view illustrating a screen displayed on a second display device when the external device connected to the first display device of a display system comprising an external device, first and second display devices according to one embodiment of the present disclosure is a DVD player.

FIG. 9 is an example of a screen in which the second controller 370 receives key information and displays a key list UI m1 on the second display 380. The key list UI m1 may be included in the overall menu m. The overall menu m may be a menu displayed to control the second display device 300 or an external device 400 when the second display device 300 receives a user input. In addition, the overall menu m may further include the key list UI m1.

In FIG. 9, it is assumed that the external device 400 connected to the first display device 100 is a DVD player. Accordingly, the key list UI m1 illustrated in FIG. 9 may be a menu m1 for controlling the DVD player.

The name of the DVD player may be displayed at the top of the menu m1 for controlling the DVD player so that it can be recognized that it is a menu m1 for controlling the DVD player. In other words, the name of the auxiliary device 400 may be displayed at the top of the menu m1 for controlling the external device 400 so that it can be recognized that it is a menu m1 for controlling the external device 400.

The key list UI m1 may include items corresponding to the key types, and the items corresponding to the key types may include icons corresponding to the key names.

A menu m1 for controlling a DVD player may include items corresponding to the key types, such as items m1-2 corresponding to function keys and items m1-3 corresponding to player keys, as illustrated in FIG. 8. However, unlike FIG. 8, the menu m1 for controlling a DVD player may not include items m1-1 corresponding to number keys and items m1-3 corresponding to color keys.

The items m1-2 corresponding to the function keys of FIG. 9 may include icons corresponding to the keys whose key names are ‘Power’, and ‘Home’, as in FIG. 8. However, unlike FIG. 8, the items m1-2 corresponding to the function keys of FIG. 9 may not include icons corresponding to the keys whose key names are ‘Menu’ and ‘Preferred Channel’, and may further include icons corresponding to the keys whose key names are ‘Disk Menu’.

The items m1-4 corresponding to the player keys of FIG. 9 may include icons corresponding to the keys whose key names are ‘Rewind m1-41’, ‘Play’ m41-42, ‘Pause’ m41-43, ‘Fast Forward m41-44’, and ‘Stop’ m41-45, as in FIG. 8. However, the items m1-4 corresponding to the player keys of FIG. 9 may further include icons corresponding to the keys whose key names are ‘Move to Previous Scene’ m1-46 and ‘Move to Next Scene’ m1-47, unlike FIG. 8.

Meanwhile, the menu m2 for controlling the second display device 300 may be displayed in the same manner as in FIG. 8. If the second display device 300 is a display device of the same type and model, the menu m2 for controlling the second display device 300 may be displayed in the same manner regardless of the external device 400 connected to the first display device 100 as illustrated in FIGS. 8 and 9.

FIG. 9(b) is an example of a screen displayed on a second display device 300 with an image provided by a DVD player operating based on a control signal.

Specifically, FIG. 9(b) may be a screen displayed when the second controller 370 receives a user input for selecting an icon corresponding to the ‘Move to next scene’ m1-47 key included in the menu m1 for controlling the DVD player.

When the second controller 370 receives a user input for selecting an icon corresponding to the ‘Move to the next scene’ m1-47 key, the second controller 370 transmits key data of the ‘Move to the next scene’ m1-47 key to the first display device 100, and the first controller 170 can generate a control signal corresponding to the ‘Move to the next scene’ m1-47 key based on the received key data and transmit the control signal to the DVD player. Then, the set-top box that receives the control signal corresponding to the ‘Move to the next scene’ m1-47 key can move to the next scene and provide an image as in the case where it directly receives a user input for selecting the ‘Move to the next scene’ m1-47 key. Accordingly, the second display 380 can display an image provided by the DVD player moving to the next scene.

In other words, the user can control the DVD player using the second display device 300.

In summary of FIGS. 8 and 9, the items included in the menu for controlling the DVD player may be partially or completely different from the items and icons included in the menu for controlling the set-top box. In other words, the types and names of keys included in the key information for controlling the external device 400 may be partially or completely different according to the external device 400.

A display system according to one embodiment of the present disclosure can provide a key list UI for controlling each of various external devices 400, even if some or all of the keys for controlling the external devices 400 are different according to the external devices 400.

Accordingly, the user can intuitively control all functions of various external devices 400 from the second display device 300 regardless of the type of external device 400, which has the advantage of increased convenience of use.

A user of a display device or display system according to one embodiment of the present disclosure can use an external device 400 without limitation without directly connecting the external device 400 to each display device.

In addition, since a user of a display device or display system according to an embodiment of the present disclosure does not need to move close to an external device 400 to control the external device 400, there is an advantage in that continuity of use of the second display device 300 is maximized.

According to one embodiment of the present disclosure, the above-described method can be implemented as a processor-readable code on a medium in which a program is recorded. Examples of the processor-readable medium include a ROM, a RAM, a CD-ROM, a magnetic tape, a floppy disk, an optical data storage device, and the like.

The display device described above is not limited to the configuration and method of the embodiments described above, and the embodiments may be configured by selectively combining all or part of the embodiments so that various modifications can be made.

1. A first display device, comprising:
an external device interface connecting with at least one external device;
a wireless communication interface connecting with at least one second display device; and
a controller transmitting key information for controlling the external device to the second display device.

2. The first display device of claim 1,
wherein the controller transmits a signal including information indicating whether the key information can be transmitted to the second display device when connected to one of the external device or the second display device while connected to the other one.

3. The first display device of claim 1,
wherein the controller transmits the key information to the second display device when receiving a signal requesting the key information from the second display device.

4. The first display device of claim 1,
wherein the controller obtains whether there is a change in the key information from an external server, and if there is a change in the key information, receives the changed key information and transmits the changed key information to the second display device.

5. The first display device of claim 1,
wherein the controller receives key data selected from the second display device from the second display device, and generates a control signal for controlling the external device based on the selected key data and transmits the control signal to the external device.

6. The first display device of claim 5,
wherein the controller generates the control signal using one of CEC, a wireless network, and IR, and transmits the control signal to the external device.

7. The first display device of claim 6,
wherein the controller generates the control signal using one of the wireless network, CEC and IR based on a priority set according to the external device, and transmits the control signal to the external device.

8. The first display device of claim 6,
wherein the controller generates the CEC signal from the external device and transmits the CEC signal to the external device when the external device is connected to the first display device by wire and the external device is an external device controllable by the CEC method.

9. The first display device of claim 8,
wherein the controller generates the IR signal and transmits the IR signal to the external device when the external device is an external device that is not controllable by the CEC method.

10. The first display device of claim 6,
wherein the controller generates a network signal and transmits the network signal to the external device when the first display device and the external device are wirelessly connected and the external device is an external device that can be controlled in a network manner.

11. The first display device of claim 10,
wherein the controller generates the IR signal and transmits the IR signal to the external device when the external device is an external device that cannot be controlled in a network manner.

12. A display system comprising a first display device and a second display device wirelessly connected to the first display device, wherein the first display device comprises:
an external device interface connecting with at least one external device; and
a first controller transmitting key information for controlling the external device to the second display device; and
wherein the second display device comprises:
a second controller displaying at least one icon corresponding to the key information received from the first controller.

13. The display system of claim 12,
wherein the first controller transmits a signal including whether the key information can be transmitted to the second display device when connected to one of the external device or the second display device while connected to the other one, and
wherein the second controller displays a message including whether the external device can be controlled based on the signal including whether the received key information can be transmitted.

14. The display system of claim 12,
wherein the second controller receives a user input for selecting one of the at least one icon and transmits key data corresponding to the selected icon to the first display device.

15. The display system of claim 14,
wherein the first controller generates a control signal for controlling the external device based on key data received from the second controller and transmits the control signal to the external device.

16. The display system of claim 15,
wherein the first controller receives at least a part of an image signal and an audio signal from an external device controlled based on the control signal and transmits at least a part of the image signal and the audio signal received from the external device to the second controller.
